(19) United States
(12) Patent Application Publication
(10) Pub. No.: US 2013/0086325 A1
(43) Pub. Date: Apr. 4, 2013

(54) DYNAMIC CACHE SYSTEM AND METHOD OF FORMATION

(71) Applicant: Moon J. Kim, Wappingers Falls, NY (US)

(72) Inventor: Moon J. Kim, Wappingers Falls, NY (US)

(21) Appl. No.: 13/252,397

(22) Filed: Oct. 4, 2011

(51) Int. Cl. G06F 12/08

(52) U.S. Cl. 711/122; 711/E12.024

(57) ABSTRACT

Embodiments of the present invention provide a dynamic cache system comprising: a multi-level inspector design that handles multi-level data formats; a cache function design that handles multi-level data formats; a cache size controller design that is able to handle the varying cache sizes based on characteristics such as hit-rates, usage patterns, etc.; a cache behavior controller design that handles different types of files; and heterogeneous storage controller design that is configured to handle volumes of the storage based on the types of storage (RAM Disk, flash, HDD, etc.). Advantages of system include (among others): caching for different types of data when different types of data need to be cached, and/or cache size can be allocated based on the cache level (which itself can be established).

### FIELD OF THE INVENTION

The present invention relates to a dynamic cache system and method of formation. Specifically, the present invention relates to a cache solution having at least one multi-level inspector that handles multi-level data formats.

### BACKGROUND OF THE INVENTION

As main memories continue to grow larger and processors run faster, the disparity in their operating speeds has widened. As a result, a cache that bridges the gap by storing a portion of main memory in a smaller and faster structure has become increasingly important. When the processor core needs data, it first checks the cache. If the cache presently contains the requested data (a cache hit), it can be retrieved far faster than resorting to main memory (a cache miss).

Existing cache solutions typically define a cache as one level (e.g., a byte, a block, a file, a disk, a network, etc.). As such, depending on the characteristics of an underlying application, new cache settings may frequently be needed. Moreover, when multiple applications are running at the same time, cache performance will often be degraded.

Heretofore, various solutions have been attempted:

U.S. Patent Application No. 2008/0109424 discloses database management systems and methods for searching a database. In one embodiment, an inspector examines a plan cache or a program containing embedded queries.

U.S. Pat. No. 6,092,153 discloses improved memory bandwidth by having a compiler group contiguous memory requests.

U.S. Pat. No. 6,985,249 I. discloses a method for processing raw application data, which includes a plurality of occurrences of an object, receives a stream of the raw application data into a job inspector.

U.S. Pat. No. 7,336,284 discloses a memory architecture for use in a graphics processor including a main memory, a level one (L1) cache and a level two (L2) cache, coupled between the main memory and the L1 cache.

U.S. Pat. No. 7,685,372 to Chen et al. discloses a digital system that connects to a bus that employs physical addresses comprising a processing core.

U.S. Pat. No. 7,949,833 also discloses a digital system that connects to a bus that employs physical addresses comprising a processing core.

### SUMMARY OF THE INVENTION

Embodiments of the present invention provide a dynamic cache system comprising: a multi-level inspector design that handles multi-level data formats; a cache function design that handles multi-level data formats; a cache size controller design that is able to handle the varying cache sizes based on characteristics such as hit-rates, usage patterns, etc.; a cache behavior controller design that handles different types of files; and a heterogeneous storage controller design that is configured to able to handle volumes of the storage based on the types of storages (RAM Disk, flash, HDD, etc). Among other things, this system provides: caching for different types of data when different types of data need to be cached, and/or cache size can be allocated based on the cache level (which itself can be established).

A first aspect of the present invention provides a dynamic cache system, comprising: a heterogeneous storage controller; a set of multi-level inspectors coupled to the heterogeneous storage controller; a set of cache behavior controllers coupled to the set of multi-level inspectors; a set of cache size controllers coupled to the set of multi-level inspectors; and a set of cache storage units coupled to the set of cache size controllers.

A second aspect of the present invention provides a dynamic cache system, comprising: a heterogeneous storage controller; a plurality of multi-level inspectors coupled to the heterogeneous storage controller; a plurality of cache behavior controllers coupled to the plurality set of multi-level inspectors; a plurality of cache size controllers coupled to the plurality of multi-level inspectors; and a plurality of cache storage units coupled to the plurality of cache size controllers, the plurality of cache storage units each comprising a plurality of levels.

A third aspect of the present invention provides a method for forming a method, comprising: coupling a set of multi-level inspectors to a heterogeneous storage controller; coupling a set of cache behavior controllers to the set of multi-level inspectors; coupling a set of cache size controllers to the set of multi-level inspectors; and coupling a set of cache storage units to the set of cache size controllers.

### BRIEF DESCRIPTION OF THE DRAWINGS

These and other features of this invention will be more readily understood from the following detailed description of the various aspects of the invention taken in conjunction with the accompanying drawings in which:

FIG. 1 is a block diagram of a two-level cache architecture.

FIG. 2 is a graphical description of address fields within a cache.

FIG. 3 is a block diagram of a single inspector cache solution.

FIG. 4 is a block diagram of a multi-level cache solution according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Exemplary embodiments will now be described more fully herein with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limited to this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” means a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms such as those defined in commonly used dictionaries should be interpreted as having a meaning that is consistent with their meaning in the context of the relevant art and the present disclosure, and will not be interpreted in an idealized or overly formal sense unless expressly so defined herein.

As indicated above, embodiments of the present invention provide a dynamic cache system comprising: a multi-level inspector design that handles multi-level data formats; a cache function design that handles multi-level data formats; a cache size controller design that is able to handle the varying cache sizes based on characteristics such as hit-rates, usage patterns, etc.; a cache behavior controller design that handles different types of files; and a heterogeneous storage controller design that is configured to handle volumes of the storage based on the types of storages (RAM Disk, flash, HDD, etc.). Among other things, this system provides: caching for different types of data when different types of data needs to be cached, and/or cache size can be allocated based on the cache level (which itself can be established).

A cache is a place to store data temporarily. The files a user automatically requests by looking at a web page are stored on the user's hard disk in a cache subdirectory under the directory for the web browser (for example, Internet Explorer). When a viewer of a web page returns to a page the viewer recently looked at, the browser can get it from the cache rather than the original server, saving you time and the network the burden of some additional traffic. You can usually vary the size of your cache, depending on your particular browser.

Computers include caches at several levels of operation, including cache memory and a disk cache. Caching can also be implemented for Internet content by distributing it to multiple servers that are periodically refreshed. (The use of the term in this context is closely related to the general concept of a distributed information base.) Altogether, several types of caches exist:
International, national, regional, organizational and other “macro” caches to which highly popular information can be distributed and periodically updated and from which most users would obtain information.
Local server caches (for example, corporate LAN servers or access provider servers that cache frequently accessed files). This is similar to the previous idea, except that the decision of what data to cache may be entirely local.
A web browser's cache, which contains the most recent Web files that you have downloaded and which is physically located on your hard disk (and possibly some of the following caches at any moment in time).
A disk cache (either a reserved area of RAM or a special hard disk cache) where a copy of the most recently accessed data and adjacent (most likely to be accessed) data is stored for fast access.
RAM itself, which can be viewed as a cache for data that is initially loaded in from the hard disk (or other I/O storage systems).
L2 cache memory, which is on a separate chip from the microprocessor but faster to access than regular RAM.
L1 cache memory on the same chip as the microprocessor.

In one of these examples, cache memory is realized in the form of RAM that a computer microprocessor can access more quickly than it can access regular RAM. As the microprocessor processes data, it looks first in the cache memory and if it finds the data there (from a previous reading of data), it does not have to do the more time-consuming reading of data from larger memory.

Cache memory is sometimes described in levels of closeness and accessibility to the microprocessor. An L1 cache is on the same chip as the microprocessor. (For example, the PowerPC 601 processor has a 32 kilobyte level-1 cache built into its chip.) L2 is usually a separate static RAM (SRAM) chip. The main RAM is usually a dynamic RAM (DRAM) chip. In addition to cache memory, one can think of RAM itself as a cache of memory for hard disk storage since all of RAM's contents come from the hard disk initially when you turn your computer on and load the operating system (you are loading it into RAM) and later as you start new applications and access new data. RAM can also contain a special area called a disk cache that contains the data most recently read in from the hard disk.

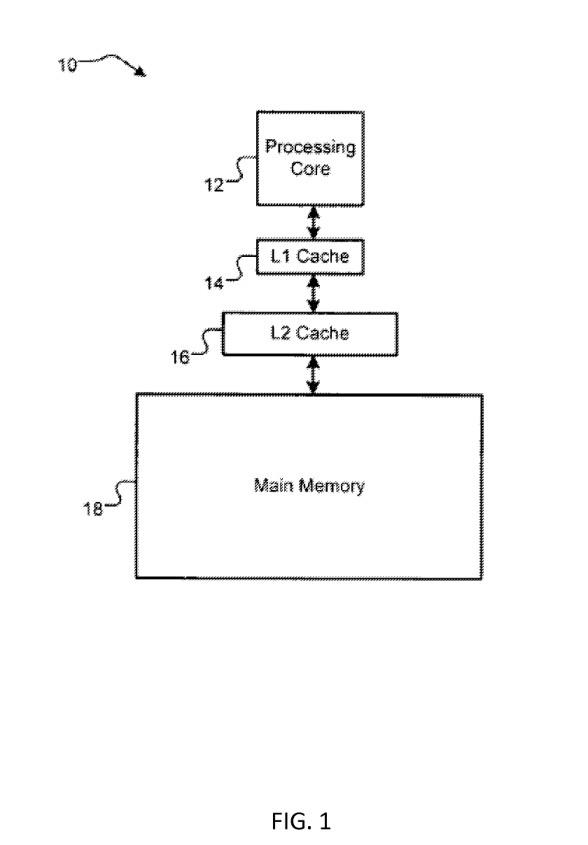

There are often multiple caches between the processing core and main memory in what is referred to as a memory hierarchy. Referring to FIG. 1, a generic two level cache architecture 10 is shown. A processing core 12 communicates with a level one (L1) cache 14 which in turn communicates with a level two (L2) cache 16. The L2 cache 16 communicates with main memory 18. Hierarchies including even a third (L3) cache are not uncommon. The hierarchy levels nearest the processing core 12 are the fastest, but store the least amount of data.

In a typical 32-bit system, each individual 32-bit address refers to a single byte of memory. Many 32-bit processors access memory one word at a time, where a word is equal to four bytes. Caches usually store data in groups of words called cache lines. For illustrative purposes, consider an exemplary cache having eight words per cache line. The four addressable bytes in each word require that the two least significant bits (2.sup.2=4 bytes in each word) in the 32-bit address select a particular byte from a word. With eight words in a cache line, the next three least significant bits (2.sup.3=8 words in each line) in the address select a word from a given cache line.

In traditional embodiments, a cache contains storage space for a limited number of cache lines. The cache controller must therefore decide which lines of memory are to be stored in the cache and where they are to be placed. In the most straightforward placement method, direct mapping, there is only one location in the cache where a given line of memory may be stored. In a two-way set-associative cache, there are two locations in the cache where a given line of memory may be stored. Similarly, in an “n”-way set associative cache, there are “n” locations in the cache where a specific line of memory may be stored. In the extreme case, “n” is equal to the number of lines in the cache, the cache is referred to as fully associative, and a line of memory may be stored in any location within the cache.

Direct mapping generally uses the low order bits of the address to select the cache location in which to store the memory line. For instance, if there are 2.sup.k cache lines,“k” low order address bits determine which cache location to store the data from the memory line into. These “k” address bits are often referred to as the index. Because many memory lines map to the same cache location, the cache must also store an address tag to signify which memory line is currently stored at that cache location.

Returning to the exemplary eight word per line cache, assume that the cache contains 4,096 (2.sup.12) cache lines. This configuration will result in a cache size of 128 KB (2.sup.12 lines*2.sup.3 words per line*2.sup.2 bytes per word=2.sup.17 bytes). With 2.sup.12 cache lines, the 12 low order address bits will be used to decide which location in the cache a memory line will be stored at. The 32-bit address space of the memory can accommodate 2.sup.32 bytes (4 GB), or 2.sup.27 cache lines. This means that there are 32,768 (2.sup.27/2.sup.12=2.sup.15) memory lines that map to each cache location. A tag field must thus be included for each cache location to determine which of the 2.sup.15 memory lines is currently stored.

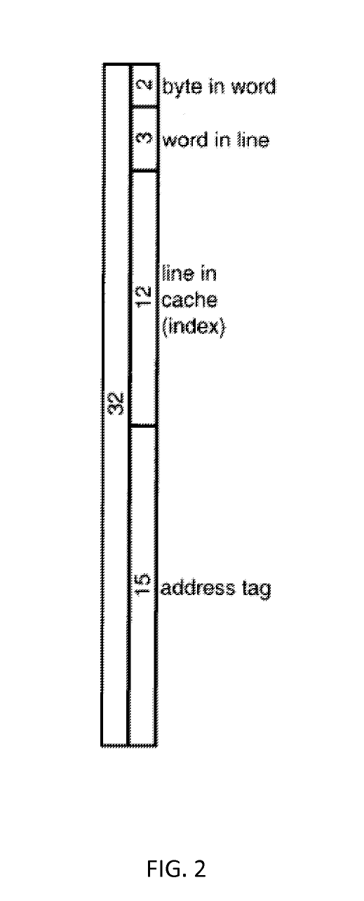

The five least significant bits in the address select a byte from a cache line. Three bits select a word from the cache line, and two bits select a byte within the word. Twelve bits form the index to select one of the 2.sup.12 cache lines from the cache. The fifteen-bit address tag allows the complete 32-bit address to be formed. These fields are depicted graphically in FIG. 2.

Many computer systems currently allow the use of more memory than is physically available through the use of virtual memory. At its essence, virtual memory allows individual program processes to run in an address space that is larger than is physically available. The process simply addresses memory as if it were the only process running. This is a virtual address space unconstrained by the size of main memory or the presence of other processes. The process can access virtual memory starting at 0x0, regardless of what region of physical memory is actually allocated to the process. A combination of operating system software and physical hardware translates between virtual addresses and the physical domain. If more virtual address space is in use than exists in physical main memory, the operating system will have to manage which virtual address ranges are stored in memory, and which are located on a secondary storage medium such as magnetic disk.

Level one (L1) caches are often located on the same die as the processing core. This allows very fast communication between the two and permits the L1 cache to run at processor speed. A level two (L2) cache located off chip requires more than a single processor cycle to access data and is referred to as a multi-cycle cache. Main memory is even slower, requiring tens of cycles to access. In order for the L1 cache to operate at processor speed, the L1 cache typically uses the virtual addressing scheme of the processor. This avoids the overhead of virtual-physical translation in this critical path.

While the L1 cache is examined to determine if it contains the requested address, the virtual address is translated to a physical address. If the L1 cache does not contain the requested address, the L2 cache is consulted using the translated physical address. The L2 cache can then communicate with the bus and main memory using physical addresses.

Cache coherence is a key concern when using caches. Operations such as direct memory access (DMA) request direct access to the main memory from the processor. Data that has been cached in the L1 or L2 caches may have been changed by the processor since being read from main memory. The data subsequently read from main memory by the DMA device would therefore be outdated. This is the essence of the problem of cache coherence.

One technique for enforcing cache coherence is to implement a write-through architecture. Any change made to cached data is immediately propagated to any lower level caches and also to main memory. The disadvantage to this approach is that writing through to memory uses precious time, and may be unnecessary if further changes are going to be made prior to data being needed in main memory. Most current cache configurations instead use write-back mode. In write-back mode, a change made to the contents of a cache is not propagated through to memory until specifically instructed to. A piece of data that has been changed in a cache but not yet propagated through to the next level of cache or to main memory is referred to as dirty. The cache location can be “cleaned” by directing the cache to be written back to the cache below or to the memory, thereby making the piece of data clean, or coherent. This may happen at regular intervals, when the memory is available, or when the processor determines that a certain location of memory will need the updated value.

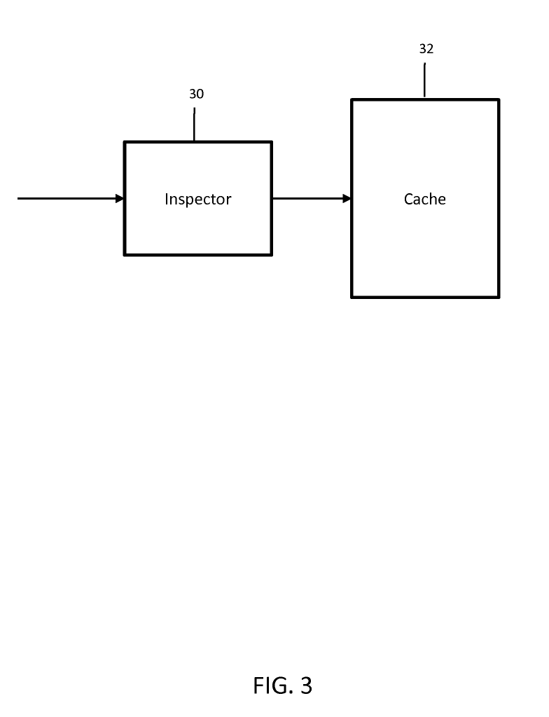

Referring now to FIG. 3, a previous approach is depicted. As shown, a single inspector 30 is coupled to a single cache 32, which comprises one level (e.g., byte, block, file, disk, or network). Depending on the characteristics of an underlying application, new cache settings are repeatedly needed. Moreover, when multiple applications are running at the same time, the cache performance will be degraded. Since cache 32 can use only one unique format per application, its performance will be reduced when other types of applications are running simultaneously.

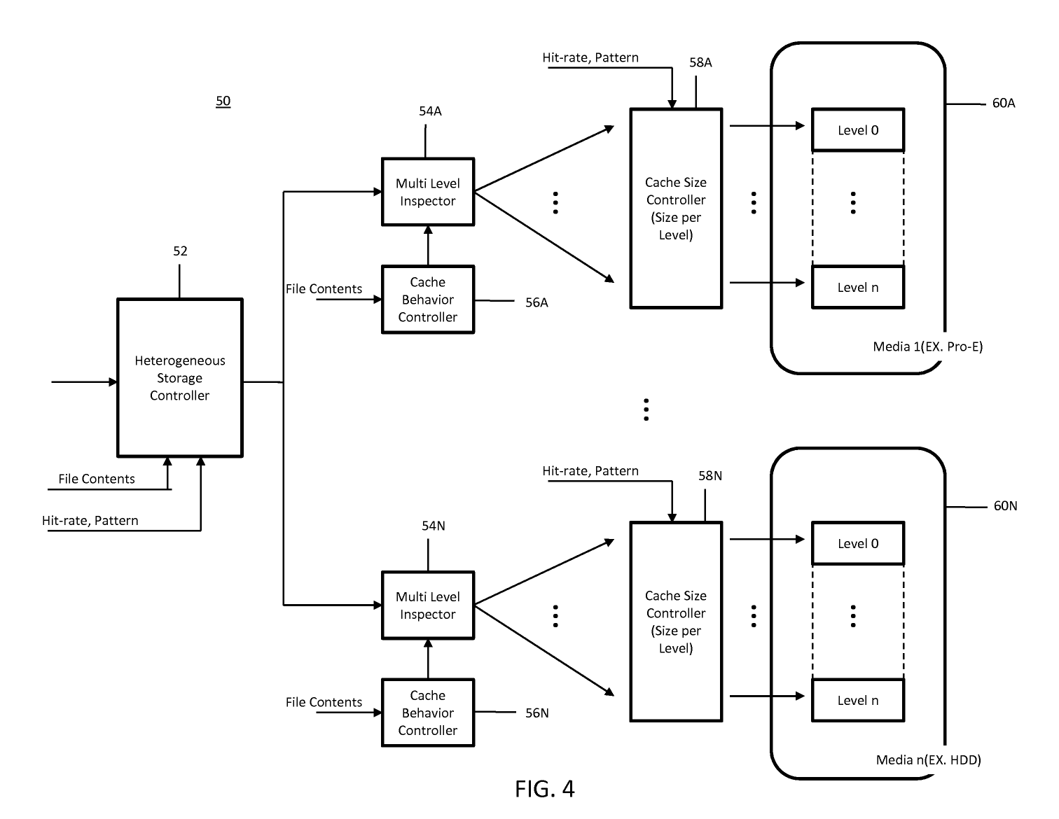

Referring to FIG. 4, a dynamic cache system 50 according to an embodiment of the present invention is shown. Among other things, system 50 provides the following: a multi-level inspector 54A-N design that handles multi-level data formats; a cache function 60A-N design that handles multi-level data formats; a cache size controller 58A-N design that is able to handle the varying cache sizes based on characteristics such as hit-rates, usage patterns, etc.; a cache behavior controller 56A-N design that handles different types of files; and heterogeneous storage controller 52 design that is configured to able to handle volumes of the storage based on the types of storages (RAM Disk, flash, HDD, etc). Advantages of system 50 include (among others): caching for different types of data; when different types of data needs to be cached, cache efficiency increases accordingly; cache size can be allocated based on the cache level (which itself can be established).

As specifically depicted in FIG. 4, system 50 comprises heterogeneous storage controller 52 coupled to a set (at least one) of multi level inspectors 54A-N, which are themselves controlled (e.g., based upon file type/contents) by a set of cache behavior controllers 56A-N. Coupled to multi level inspectors 54A-N is a set of cache size controllers 58A-N, which control levels 0-N of cache storage units 60A-N based on characteristics such as hit rate, pattern, etc.

In general (although not shown), heterogeneous storage controller 52, multi level inspectors 54A-N, cache behavior controllers 56A-NA, and/or cache size controllers 58A-N can comprise and/or interact with one or more of the following components/functions: an input/out (I/O) traffic analysis component for analyzing/monitoring data traffic being received; an adaptive cache algorithm component for applying a set of algorithms to determine the manner and location (i.e., a schema) in which data received should be cached; and/or an adaptive cache policy component for applying caching policies and making storage determinations based on the traffic analysis and/or results of cache algorithm computation(s).

It is understood that although not shown, other cache elements could augment the components shown in FIG. 4. For example, a cache manager could be provided that includes: a cache balancer coupled to a set of cache meta data units; a set of cache algorithms that utilize the set of cache meta data units to determine optimal data caching operations; a cache adaptation manger coupled to (and sending volume information to) a cache balancer (this information is typically computed using the set of cache algorithms); a monitoring manager coupled to the cache adaptation manager; and/or a reliability manager that receives the cache meta data units. Such a cache manager can: balance a load; send volume information to the cache balancer; collect data patterns and send the data patterns to the cache balancer; and/or be used as a buffer cache.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A dynamic cache system, comprising:
a heterogeneous storage controller;
a set of multi-level inspectors coupled to the heterogeneous storage controller;
a set of cache behavior controllers coupled to the set of multi-level inspectors;
a set of cache size controllers coupled to the set of multi-level inspectors; and
a set of cache storage units coupled to the set of cache size controllers.

2. The dynamic cache system of claim 1, the set of multi-level inspectors being configured to handle multi-level data formats.

3. The dynamic cache system of claim 1, the set of cache size controllers being configured to handle the varying cache sizes on a set of characteristics.

4. The dynamic cache system of claim 3, the set characteristics comprising at least one of the following: hit-rate, or usage pattern.

5. The dynamic cache system of claim 1, the set of cache behavior controllers being configured to handle different types of files.

6. The dynamic cache system of claim 1, the heterogeneous storage controller being configured to handle volumes of the storage based on a type of storage of the set of cache storage units.

7. The dynamic cache system of claim 6, the type of storage comprising at least one of the following: random access memory (RAM), high density disk (HDD), or flash memory.

8. The dynamic cache system of claim 1, the set of cache storage units comprising a plurality of storage levels.

9. A dynamic cache system, comprising:
a heterogeneous storage controller;
a plurality of multi-level inspectors coupled to the heterogeneous storage controller;
a plurality of cache behavior controllers coupled to the plurality set of multi-level inspectors;
a plurality of cache size controllers coupled to the plurality of multi-level inspectors; and
a plurality of cache storage units coupled to the plurality of cache size controllers, the plurality of cache storage units each comprising a plurality of levels.

10. The dynamic cache system of claim 9, the plurality of multi-level inspectors being configured to handle multi-level data formats, and the plurality of cache behavior controllers being configured to handle different types of files.

11. The dynamic cache system of claim 9, the plurality of cache size controllers being configured to handle the varying cache sizes on a plurality of characteristics, the plurality characteristics comprising at least one of the following: hit-rate, or usage pattern

12. The dynamic cache system of claim 9, the heterogeneous storage controller being configured to handle volumes of the storage based on a type of storage of the plurality of cache storage units, and the type of storage comprising at least one of the following: random access memory (RAM), high density disk (HDD), or flash memory.

13. A method for forming a method, comprising:
coupling a set of multi-level inspectors to a heterogeneous storage controller;
coupling a set of cache behavior controllers to the set of multi-level inspectors;
coupling a set of cache size controllers to the set of multi-level inspectors; and
coupling a set of cache storage units to the set of cache size controllers.

14. The method of claim 13, the set of multi-level inspectors being configured to handle multi-level data formats.

15. The method of claim 13, the set of cache size controllers being configured to handle the varying cache sizes on a set of characteristics.

16. The method of claim 15, the set characteristics comprising at least one of the following: hit-rate, or usage pattern.

17. The method of claim 13, the set of cache behavior controllers being configured to handle different types of files

18. The method of claim 13, the heterogeneous storage controller being configured to handle volumes of the storage based on a type of storage of the set of cache storage units.

19. The method of claim 18, the type of storage comprising at least one of the following: random access memory (RAM), high density disk (HDD), or flash memory.

20. The method of claim 13, the set of cache storage units comprising a plurality of storage levels.
